(19) United States
(12) Patent Application Publication
(10) Pub. No.: US 2002/0198011 A1
(43) Pub. Date: Dec. 26, 2002

(54) Simultaneous data transmission/polling method

(76) Inventor: Walter Simbirski, Calgary (CA)

Correspondence Address: BENNETT JONES LLP, 4500 Bankers Hall East, 855 - 2nd Street SW, Calgary, AB, T2P 4K7, CA

(21) Appl. No.: 09/898,451

(22) Filed: Jul. 5, 2001

(30) Foreign Application Priority Data
Jun. 22, 2001 (CA) 2351269

(51) Int. Cl. H04B 7/005

(52) U.S. Cl. 455/502; 455/503

(57) ABSTRACT

A method for polling a plurality of wireless modems from a base station in which, when a first modem is about to be polled, data that is ready to sent to a second modem is included in the poll sent to the first modem. The poll includes an indication that the data is intended for the second modem.

### FIELD

This invention relates generally to the field of network management and, in particular, to a method for efficient polling of wireless modems.

### BACKGROUND

A wireless modem is a data communication device that comprises at least two data communication ports, at least one of which is a wireless data port enabling the wireless modem to communicate with one or more other wireless modems via a radio frequency (“RF”) link. The other communication port or ports may be connected to a a computer or a data network by wire line connections using Ethernet, USB, RS-232, or other protocols, or may be wireless. To simplify the following description, we will consider a wireless modem to have two communication ports—one an RF link for communicating with other wireless modems and the other a wire line link for communication with a single computer or a data network. Ethernet will be used as exemplary protocol for the wire line link in the following discussion.

Wireless modems are typically used to link together wire line data networks that are geographically separated. The wireless modems in that case act as bridges between the wire line data networks. An example of such use is shown in FIG. 1. A first local area network 10 is connected by wire line 12 to a first wireless modem 14. Similarly a second local area network 16 is connected by wire line 18 to a second wireless modem 20. The two wireless modems 14, 20 communicate via an RF link 22, shown connecting wireless modem 14 with wireless modem 20 through free space separating the modems 14, 20.

In order for wireless modems to be used in a variety of data networks supporting different communication protocols, and to facilitate efficient operation on their RF links, wireless modems typically use protocol layering. Regardless of the protocol used on the wired link, when a data packet is received by a wireless modem on its wired link and is to be transmitted on its RF link, the wireless modem encapsulates the wire line data packet within an RF packet containing information specific to the RF link. In essence the wire line data packet becomes the data payload for the RF data packet. The wireless modem then sends the complete RF packet on its RF link. The wireless modem that receives the packet removes the RF link specific information and then forwards the wire line portion of the packet on its wire line communication port.

A typical RF link packet 24 transmitted from wireless modem 14 to wireless modem 20 in FIG. 1 using protocol layering is shown in FIG. 2. The data contained in RF link packet 24 includes:

Synch Sequence 26—data that precedes the rest of RF link packet 24 and allows any wireless modem receiving RF link packet 24 to synchronize on the incoming data and determine where the start of the remaining data is in the packet 24.

SRC 28—an address or unique identifier of the wireless modem (“the source modem”) that transmitted RF link packet 24, in this case wireless modem 14. All wireless modems have a unique address or identifier permanently written into them during manufacture.

DEST 30—an address or unique identifier of the wireless modem (“the destination modem”) that is expected to receive RF link packet 24. Since RF is a broadcast medium all wireless modems in the receiving area will receive the RF link packet 24. Only the wireless modem that has an address or unique identifier that matches the DEST 30, in this case wireless modem 20, is expected to process RF link packet 24. All other wireless modems receiving RF link packet 24 are expected to discard it.

CONTROL 32—special control data for the destination wireless modem, in this case wireless modem 20. The control data may include an indication that the data payload (see below) is actually intended for the destination wireless modem, here wireless modem 20, and is not to be forwarded on to its associated local area network 16. Other control data may indicate that additional data packets will be following or that no acknowledgement is expected by wireless modem 20 in response to RF link packet 24.

ID 34—a unique identifier associated with RF link packet 24. Each time the source wireless modem 14 transmits a packet on RF link 22, it increments the ID of the previous packet so that each transmitted RF link packet 24 is uniquely identified.

ACK ID 36—the ID of the last uncorrupted packet that the source wireless modem 14 received from the destination modem 20.

PAYLOAD 38—the data portion of the RF link packet 24.

FCS 40—the frame check sequence. This is a value that is calculated from all of the data in the RF link packet 24, excluding the synch sequence 26 and the FCS 40. Destination wireless modem 20 recalculates the FCS 40 based on the data it receives. If the calculated value matches the value of the received FCS 40, then the payload 40 is forwarded on wire line 18, and the ID of the RF link packet 24 is stored to be used as the ACK ID 36 when next communicating with the source modem 14. If the calculated value of the FCS 40 does not match the value of the received FCS 40, then the RF link packet 24 is discarded without attempting to notify source modem 14.

Wireless modems are also used in point to multi-point wireless data communication networks, such as that shown in FIG. 3 and indicated generally by reference numeral 42. In point to multi-point wireless data communication network 42, a special form of wireless modem, base station 43, is connected by wire line 44 to a data network 45. Base station 43 receives data from data network 45 and transmits it to a group of wireless modems, a representative four of which are indicated by reference numerals 46, 48, 50, and 52 in FIG. 3, via RF links 54, 56, 58, 60, respectively. The wireless modems 46, 48, 50, 52 in turn send data via RF links 54, 56, 58, 60, respectively, directly to with the base station 43 (i.e., wireless modems 46, 48, 50, 52 do not communicate directly with each other). One common application of a point to multi-point wireless data communication network 42 is to connect a group of end users, each with one or more wireless modems 46, 48, 50, 52, to the Internet (an example of a data network 45) via the base station 43, which is maintained by an Internet Service Provider (ISP). The point to multi-point wireless data communication network 42 allows the ISP to provide Internet connectivity to its customers in a geographic area in a timely and cost efficient manner.

The base station 43 and its associated group of wireless modems 46, 48, 50, 52 all transmit data on the same RF frequency (RF channel). To avoid interference, only one of the base station 43 and its associated group of wireless modems 46, 48, 50, 52 can be transmitting data at a particular time in a geographic area. If more than one of wireless modems 46, 48, 50, 52 attempts to transmit data simultaneously, then all transmissions will be corrupted, i.e., they will interfere with each other, and the base station 43 will not be able to decipher any of the transmissions. In order to prevent communications from multiple modems from interfering with each other some method of coordinating access to the RF channel is required. For example, RF links 54, 56, 58, and 60 shown in FIG. 3 all share the same RF channel, but only one of them can be active at a time if interference is to be avoided.

Access to an RF channel can be coordinated if the base station or a wireless modem wishing to transmit data on the RF channel first listens to determine if any of the wireless modems, in the case of the base station, or the base station or any of the other wireless modems, in the case of a wireless modem, are currently transmitting. While wireless modems do not communicate directly with each other, they are able to determine if another wireless modem or the base station is currently transmitting. When neither the base station nor any of the other wireless modems are transmitting, then the RF channel is available and data can be transmitted. This technique is commonly referred to as “collision-sense multiple access with collision avoidance” (“CSMA/CA”) and is illustrated in FIG. 4, which shows a portion of network 42. In FIG. 4, wireless modem 52 has data that it wishes to send to base station 43. However, at the same time, wireless modem 46 is already sending data over RF link 54, which uses the same RF channel that wireless modem 52 would have to use to send data to base station 43. Wireless modem 52 monitors that RF channel, so if it is able to receive the RF signal being broadcast by wireless modem 46 over RF link 54, it waits until wireless modem 46 stops sending data to base station 44 before it attempt to send its data. The RF signal received by wireless modem 52 is indicated by reference numeral 62. While the RF signal broadcast by wireless modem 46 may radiate in many directions, only RF link 54 and RF signal 62 are shown in FIG. 4.

One of the difficulties with the CSMA/CA technique is that it is possible for two or more wireless modems wishing to send data at the same time to simultaneously sense that the RF channel is free and to begin transmitting at the same time. This is referred to as a collision and results in both transmissions becoming corrupted. Collisions can also occur due to “hidden nodes”. This occurs when a wireless modem is unable to sense transmissions from one or more of the other wireless modems (hidden nodes) due to obstructions or other interference. If one of these hidden nodes is currently transmitting data to the base station, the wireless modem is unable to detect this and may begin its own transmission to the base station, which will result in a collision at the base station. For example, in FIG. 5 an obstruction 64 exists between wireless modem 46 and wireless modem 52, preventing wireless modem 52 from receiving RF signal 62. Wireless modem 52 therefore attempts to send data over RF link 60 at the same time wireless modem 46 is sending data over RF link 54. Wireless modem 46 is a hidden node with respect to wireless modem 52.

As the number of wireless modems and the amount of data to be transmitted increases, the likelihood of a collision increases. Collisions can cause less efficient use of the RF channel.

An improvement to the CSMA/CA technique, that is useful during heavy traffic periods, is to use reservation slots. The group of wireless modems associated with a base station is divided into subgroups. The base station broadcasts messages to the overall group indicating which subgroup may attempt communication at any given time. Since the number of wireless modems that may access the media at any given time is reduced the chances for collisions are reduced. Careful selection of the members of a subgroup can also reduce the likelihood of hidden nodes; however, as the number of wireless modems increases, or the amount of data to be transmitted increases, the likelihood of collisions still increases. The use of reservation slots is not illustrated in the drawings.

Collisions due to high traffic load or hidden nodes can be completely avoided by using polling. In polling, the base station queries (polls) each wireless modem in round robin fashion to determine if it has data to transmit. If the wireless modem has data to transmit it responds by sending the data to the base station. If the wireless modem has no data to send it returns a special packet (a null response) indicating that it does not wish to send data. The base station receives data or a null response from the wireless modem and then polls the next wireless modem. The sequence continues until the entire list of wireless modems has been polled and then repeats. Since only one wireless modem can be transmitting at any time there is no possibility for collision. Polling is illustrated in FIG. 6, in which base station 43 is sending data to or receiving data only from wireless modem 46 over RF link 54. Each of the other wireless modems 48, 50, 52 remains inactive until it receives from base station 43 an RF packet with DEST 30 equal to its identifier.

### SUMMARY

A method for requesting data from a plurality of wireless modems from a base station that comprises, when a request for data is about to be transmitted to a first modem, including in the transmission data that is ready to be transmitted to a second modem. The transmission includes an indication that the data is intended for the second modem. By doing so data may be sent to the second modem at the same time data is requested from the first modem, thereby polling the plurality of modems more efficiently whenever the base station has no data to send to the modem to be polled.

The transmission sent to poll one of a plurality of wireless modems may include a field containing an identification of a first wireless modem, a field containing data destined for a second wireless modem, and a field containing identification of the second wireless modem.

The base station and plurality of wireless modems form a system in which the base station is programmed or configured to send assemble and send a packet to the plurality of wireless modems. The packet includes identification of a first wireless modem, a data payload destined for a second wireless modem, and identification of the second wireless modem. The first wireless modem is programmed or configured to respond with a transmission indicating whether it has data to transmit to the base station and the second wireless modem is configured to process the data payload or retransmit it.

### BRIEF DESCRIPTION OF DRAWINGS

FIG. 1 illustrates the use of wireless modems to provide a wireless bridge between two local area networks.

FIG. 2 is a schematic representation of typical RF link packet that would be transmitted from one wireless modem to another using protocol layering.

FIG. 3 is a schematic drawing showing a conventional point to multi-point wireless data communication network.

FIG. 4 is a schematic drawing showing a conventional collision sense multiple access with collision avoidance (“CSMA/CA”) method in which a base station or wireless modem wishing to transmit data on the radio link before transmitting first listens to determine if the base station or other wireless modems are currently transmitting.

FIG. 5 is a schematic drawing showing how collisions can occur in a wireless network using CSMA/CA due to “hidden nodes”.

FIG. 6 is a schematic drawing showing how collisions due to high traffic load or hidden nodes can be avoided by using polling.

FIG. 7 is a schematic representation of a modified RF link packet that may be used in accordance with the invention to send data to one wireless modem while simultaneously polling another wireless modem.

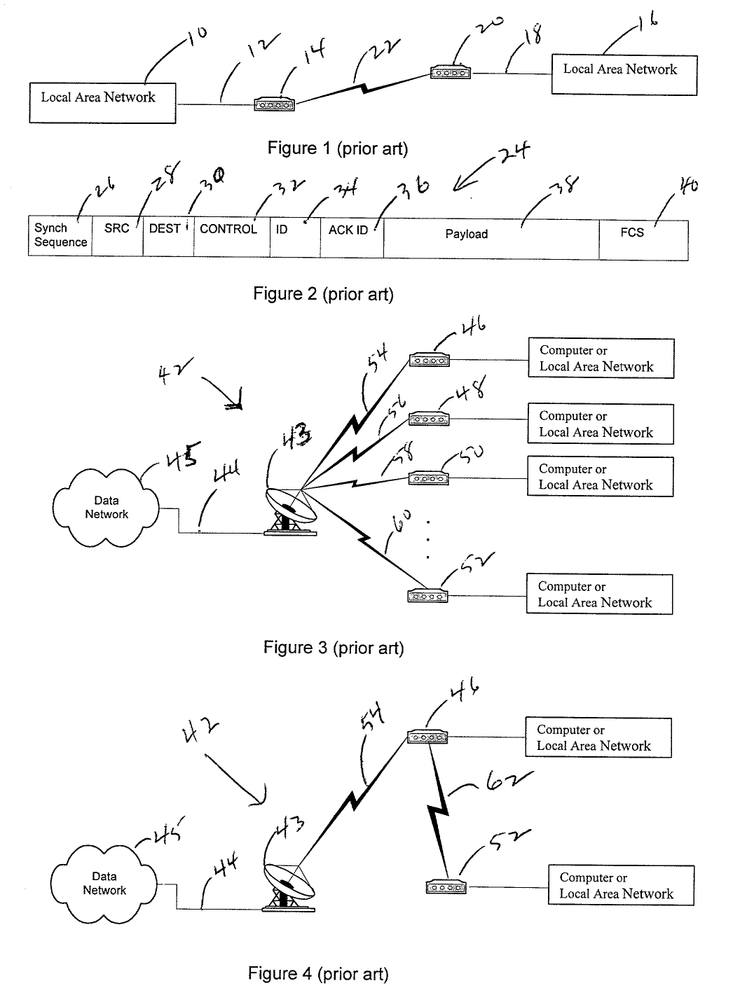

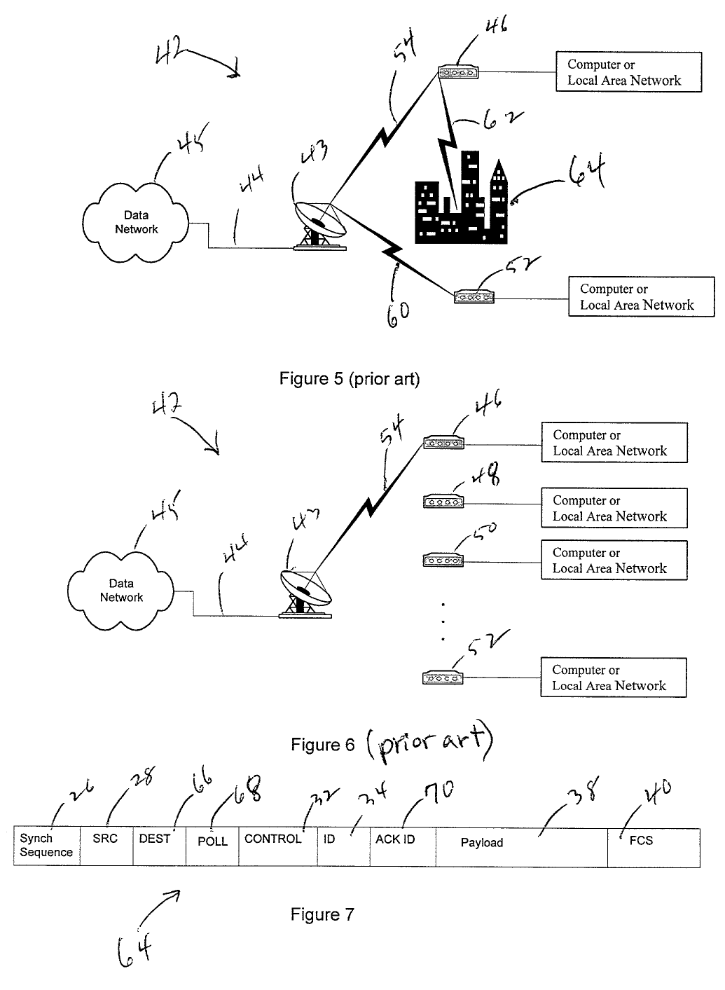

### DETAILED DESCRIPTION

The inventor, in considering how to increase the efficiency of polling wireless modems, observed that if the protocol laying illustrated in FIG. 2 is used, then the base station 43 may at times have data ready to send to a modem other than the modem to be polled next, but have to wait to send that data until the modem to which the data is destined is polled, even if no data is ready to be sent to the modem to be polled next. The inventors realized that data could reach its destination sooner and the efficiency of the use of the RF channel could be improved if data destined for one modem could be sent as part of an RF packet being sent to poll a second modem.

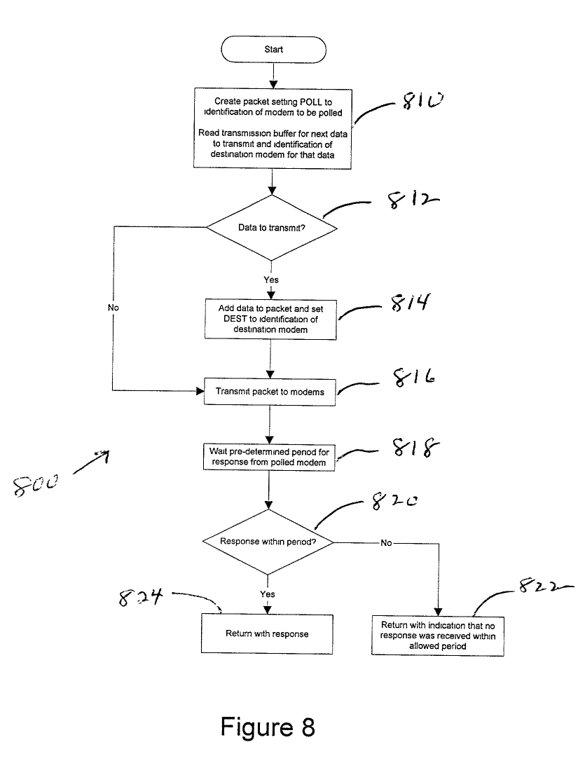

More specifically, since all modems listen to all transmissions from the base station 43, channel efficiency may be increased if a modified RF link packet 64 as shown in FIG. 7 is used every time a modem is polled. Modified RF link packet 64 differs from conventional RF link packet 24 shown in FIG. 2 in the following:

DEST 30 shown in FIG. 2 has been replaced by DEST 66, which identifies the modem for which the payload 38 is intended;

POLL 68 has been added, which identifies the modem that is expected to respond to the modified RF link packet 64, i.e., it identifies the modem being polled. It is not necessarily the same modem as that identified to by DEST 66; and

ACK ID 70 replaces ACK ID 36 and refers to the last good packet received from the modem being polled (POLL 68).

Implementation of this modification to the packet structure allows the base station 43 to poll one modem while transmitting data to another (regardless of whether the receiving station is active or inactive). In FIG. 8, a flowchart describing the assembly of a modified RF link packet 64 is provided in the form of a process, indicated generally by reference numeral 800, that would be run each time a modem is to be polled by base station 43.

The process described in FIG. 8 at step 810 creates an RF link packet 64, sets POLL 66 to the identifier of the modem to be polled, and then reads a buffer that may contain data to be sent and the identifier of the modem to which the data is to be sent. If there is data in that buffer to be sent, then in step 812 control is transferred to step 814, in which the data to be sent is added to the RF link packet 64 as payload 38 and the DEST 66 of the RF link packet 64 set to the identifier of the modem to which the data payload 38 is to be sent. If there was no data to be sent, and in any case following step 814, then the RF link packet 64 is sent by the base station 43 to the modems 46, 48, 50, 52 in step 816. The process 800 then in step 818 waits for a pre-determined period and then at step 820 checks for a response from the modem being polled and returns either an indication that no response was received in step 822 or, if a response was received, returns the response in step 824.

The process 800 described in FIG. 8 could also be used when the CSMA/CA method is used, by omitting POLL 68 and modifying CONTROL 32 to command the modems 46, 48, 50, 52 to respond using the CSMA/CA method. The result would be that data would be sent to one modem, while commanding all of the modems to respond using the CSMA/CA method.

1. A method for requesting data from a plurality of wireless modems, comprising, when data is to be requested from a first modem, including in the request transmitted to said first modem data that is ready to be transmitted to a second modem, the transmission including an indication that said data is intended for said second modem.

2. A data transmission sent to request data from one of a plurality of wireless modems, comprising:
identification of a first wireless modem;
data destined for a second wireless modem; and
identification of said second wireless modem,
whereby said data may be sent to said second wireless modem simultaneously with said request for data from said first wireless modem.

3. A wireless communication system, comprising:
a base station; and
a plurality of wireless modems,
wherein said base station is configured to send a transmission to said plurality of wireless modems, said transmission including identification of a first wireless modem, a data payload destined for a second wireless modem, and identification of said second wireless modem, and
wherein said first wireless modem is configured to respond with a transmission indicating whether it has data to transmit to said base station and said second wireless modem is configured to process said data payload or retransmit it.
